(19) United States
(12) Patent Application Publication
(10) Pub. No.: US 2023/0082413 A1
(43) Pub. Date: Mar. 16, 2023

(54) METHODS AND SYSTEMS FOR CREATING GROUND CONTROL POINTS

(71) Applicant: Intermap Technologies, Inc., Englewood, CO (US)

(72) Inventors: Qiaoping Zhang, Englewood, CO (US); Britton Armstrong, Englewood, CO (US)

(21) Appl. No.: 17/473,704

(22) Filed: Sep. 13, 2021

(51) Int. Cl. G01C 11/02; G01C 11/06

(52) U.S. Cl. CPC G01C 11/025; G01C 11/06

(57) ABSTRACT

A technique is directed to methods and systems for creating ground control points (GCPs). In some implementations, a GCP system can analyze satellite data for a location, at which multiple photons were measured, and extract terrain and canopy information from the satellite data. The GCP system can create GCPs with the extracted ICESat-2 data and calculate a quality indicator, which indicates a metric of reliability, for each GCP using photon information. In some implementations, the GCP system classifies and filters the GCPs based building footprint data, water data, forest index data, and/or landform classification mask data.

### BACKGROUND

Ground control points (GCPs) are created manually in the field by installing plates on the ground and documenting the elevation of the plate. Once the plates are installed, an aircraft can capture images of terrain which includes the plates. The images can include the points of the plates with the documented heights and new points of locations nearby the installed plates. The points of the plate locations are used as control points when creating mappings of terrain and determining the heights of the new points. However, this process is labor intensive and difficult in remote locations and can be impossible in heavily forested areas.

### BRIEF DESCRIPTION OF THE DRAWINGS

FIG. 1 is a flow diagram illustrating a process used in some implementations for creating ground control points.

FIG. 2 is a flow diagram illustrating a process used in some implementations for creating ground control points.

FIG. 3 is an illustration of a satellite image with satellite data tracks.

FIG. 4 is an illustration of a satellite image with filtered data points.

FIG. 5 is an illustration of ICESat-2 beam patterns diagrams.

FIG. 6A is an illustration ICESat-2 beam patterns from a satellite in forward orientation.

FIG. 6B is an illustration ICESat-2 beam patterns from a satellite in backward orientation.

FIG. 7 is a diagram of data points graphed by elevation error mean vs. slope/obstruction.

FIG. 8 is a diagram of data points graphed by elevation error RMSE vs. slope/obstruction.

FIG. 9 is a diagram of data points graphed by elevation error LE90 vs. slope/obstruction.

FIG. 10 is a block diagram illustrating an overview of devices on which some implementations can operate.

FIG. 11 is a block diagram illustrating an overview of an environment in which some implementations can operate.

FIG. 12 is a block diagram illustrating components which in some implementations can be used in a system employing the disclosed technology.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to methods and systems for synthesizing ground control points (GCPs). GCPs include terrain GCPs (e.g., mountain, forest, etc.) or surface GCPs (e.g., canopy, top of a structure, etc.). The ground control point (GCP) system can use ice, cloud, and land elevation satellite (ICESat) data (e.g., LiDAR altitude measurement points captured by a NASA ICESat-2 satellite) collected by sending pulses of laser light from a satellite to the earth's surface and collecting the returning photons. Currently, using ICESat-2 data for GCPs presents challenges such as directly using ICESat-2 data results in errors. Another challenge is the accuracy of the GCPs is affected by slope and surface obstruction levels and are suitable either for digital surface model (DSM) or a digital terrain model (DTM) depending on the points the satellite has imaged (e.g., buildings, vegetation, etc.). These points are not interchangeable so GCPs can only be created once they are classified, but it is not possible to determine which is which from the LiDAR data alone because all non-canopy features such as buildings are classed as terrain.

The disclosed method utilizes techniques for creating GCPs, without physical control points, for bare earth and structures such as buildings, and for temporally inconsistent points such as a forest canopy height (e.g., terrain and surface GCPs). A GCP system can analyze ICESat-2 data for a location, at which multiple photons were measured, and extract terrain and canopy information from the ICESat-2 data. The ICESat-2 data can include photon information such as the number of photons classified as terrain at that location, the number of photons classified as canopy at that location, or the number of photons classified as top of canopy at that location. The GCP system can create GCPs with the extracted ICESat-2 data. The GCP system can calculate a quality indicator, which indicates a metric of reliability, for each GCP using photon information. For example, if the quality indicator of a GCP is zero, the GCP is removed. The GCP system can classify and filter the GCPs based building footprint data, water data, forest index data, and/or landform classification mask data.

Methods and systems disclosed herein can provide technical advantages over conventional ground control point creation systems. For example the discloses GCP system provides: 1) the ability to apply quality indications to each ICESat-2 derived DTM GCP; 2) the ability to classify and filter ICESat-2 derived DTM GCPs, based on DSM, DTM and classification mask data (e.g., building, bare earth, canopy, etc.); 3) the ability to filter by slope, and obstruction level to remove photons with high error probabilities; and 4) the ability to create ICESat-2 derived DTM GCPs in thick canopy using estimations of canopy height.

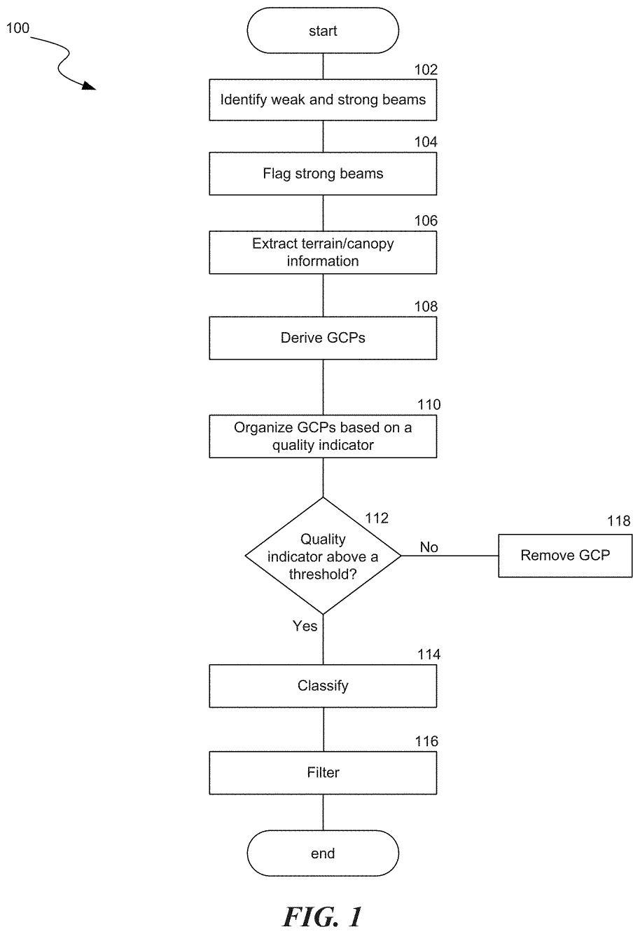

Several implementations are discussed below in more detail in reference to the figures. FIG. 1 is a flow diagram illustrating a process 100 used in some implementations for creating GCPs. In an embodiment, process 100 is triggered by a satellite sending pulses of laser light to the earth's surface and collecting the returning photons, a user inputting a command, or, when receiving satellite data of LiDAR altitude measurement points. In some implementations, digital elevation models (DEMs) represent the “bare earth” elevation, from which surface features such as trees and buildings have been removed. Either a digital surface model (DSM) or a digital terrain model (DTM) may be referred to as a DEM. Since no remote sensing mapping system provides direct measurements of the bare earth, a DTM is mostly produced by editing of the DSM.

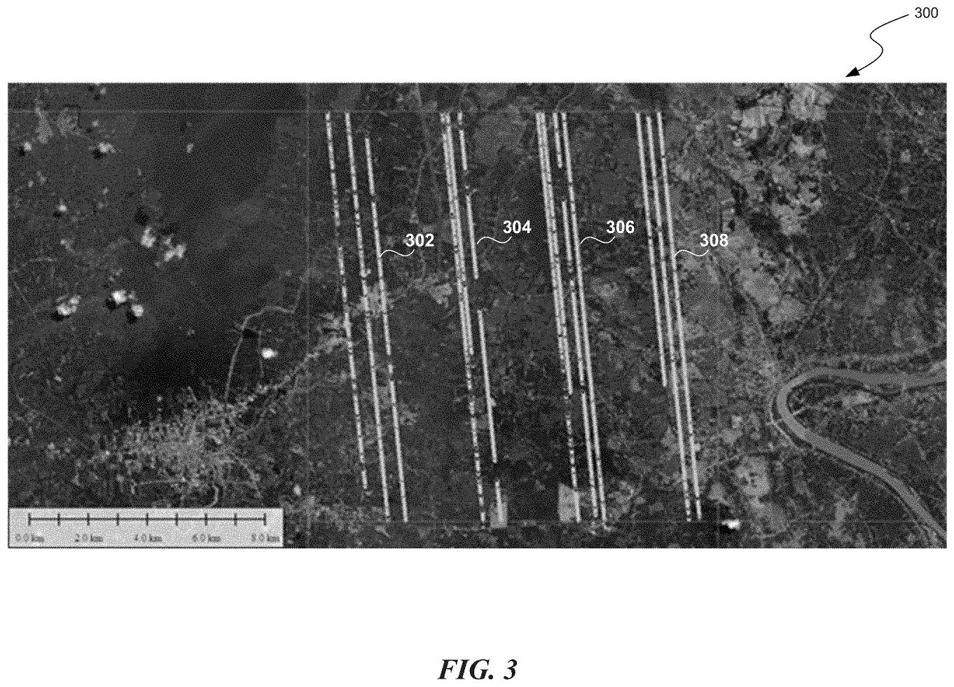

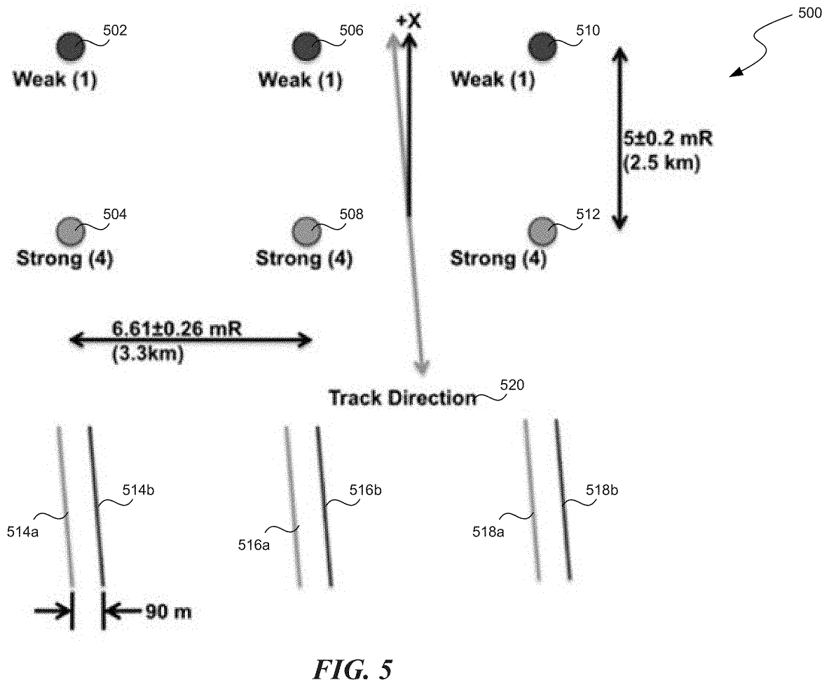

Process 100 can analyze data (e.g., ICESat-2 data) that was collected by a satellite (e.g., ICESat-2) for a location. Example 300 of FIG. 3 illustrates satellite data tracks 302, 304, 306, and 308 captured by a satellite. For example, laser pulses from a satellite (e.g., ATLAS) illuminate three left and right pairs of spots on the earth's surface that trace out six (e.g., approximately 14-meter-wide) ground tracks as ICESat-2 orbits Earth. The beams within each pair have different transmit energies (i.e., weak and strong beams) with an energy ratio (e.g. of approximately 1:4) between the beams, to compensate for varying surface reflectance. Example 500 of FIG. 5 illustrates three pairs of spots for the ground tracks. Weak beam 502 is paired with strong beam 504, weak beam 506 is paired with strong beam 508, weak beam 510 is paired with strong beam 512. The weak and strong beams an energy ratio of 1:4. The weak and strong beams in each pair of spots are separated by a distance of 5±mR (e.g., 2.5 km) and the pairs of tracks 514, 516, and 518 are separated by distance of 6.61±0.26 mR (e.g., 303 km). The tracks in each pair 514a, 514b, 516a, 516b, 518a, and 518b are separate by 90 meters.

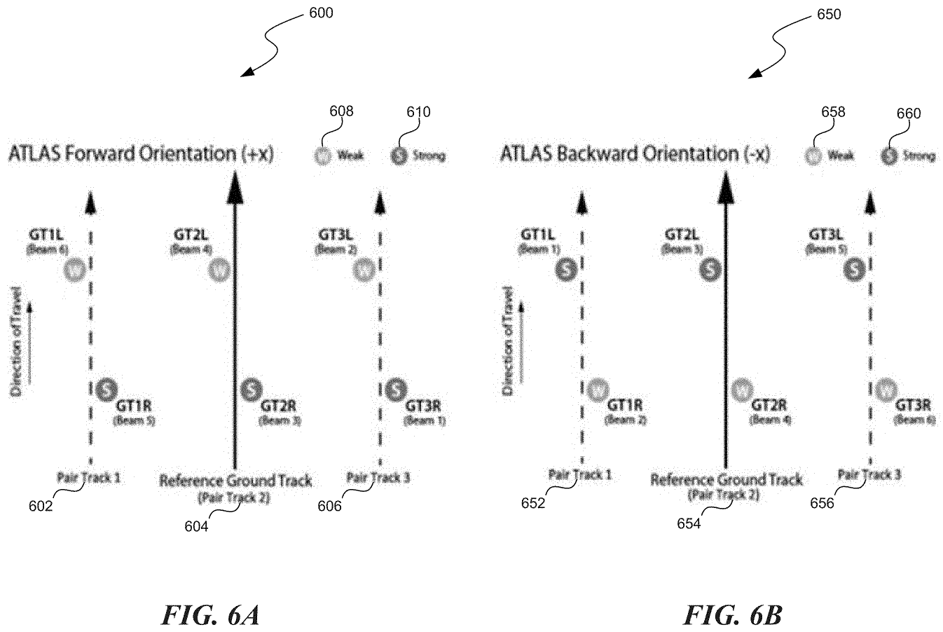

The ICESat-2 data provides strong and weak beams captured by the satellite. Strong beams occur when the satellite is in backward orientation, while weak beams occur while the satellite is in forward orientation. Example 600 of FIG. 6A illustrates ICESat-2 beam patterns of the ATLAS forward orientation. Weak beams 608 and strong beams 610 are illustrated in pair track 1 602, reference ground track (pair track 2) 604, and pair track 3 606. Example 650 of FIG. 6B illustrates ICESat-2 beam patterns of the ATLAS backward orientation. Weak beams 658 and strong beams 660 are illustrated in pair track 1 652, reference ground track (pair track 2) 654, and pair track 3 656. Strong beams can contain more photon data than weak beams, making strong beams more reliable for validation. At step 102, process 100 identifies the weak and strong beams. At step 104, process 100 flags the strong and weak beams, such as a flag of 1 is used for strong beams, while a flag of 0 is used for weak beams.

At step 106, process 100 extracts terrain and canopy information from the ICESat-2 data. The ICESat-2 data provides photon classification flags for terrain, canopy, top of canopy and noise. Photons classified as noise are removed before GCP creation. Process 100 can verify there is an estimated number of measured photons or a minimum threshold (e.g., a percentage that is satisfied) of measured photons for a location before creating GCPs at the location. Process 100 can determine the number of measured photons for a location from the photon data (e.g., data extracted from ICESat-2 products ATL03 and ATL08).

At step 108, process 100 creates/derives GCPs by combining multi photons that fall within a set radius from the ICESat-2 data using 3D coordinates measured by the LiDAR satellite. For each GCP, The ICESat-2 data within the set radius can include photon information such as the longitude, latitude, DeltaH (maximum height—minimum height) at that location, number of photons classified as terrain at that location, number of photons classified as canopy at that location, number of photons classified as top of canopy at that location, maximum height of all photons at that location, minimum height of all photons at that location, mean height of all photons at that location, maximum height of all terrain photons at that location, minimum height of all terrain photons at that location, and the mean height of all terrain photons at that location. Process 100 can generate a comma-separated values (CSV) file with the ICESat-2 data for each GCP. In some implementations, process 100 generates a raster file (e.g., .BIL file) for the maximum height of all photons at that location, the minimum height of all photons at that location, the mean height of all photons at that location, the maximum height of all terrain photons at that location, the minimum height of all terrain photons at that location, and the mean height of all terrain photons at that location (e.g., 6 .BIL files in total).

At step 110, process 100 organizes the GCPs based on a calculated quality indicator for each GCP. Process 100 calculates a quality indicator for each GCP based on the photon information. In an example, the quality indicator has a value of 1 if at least one photon from terrain and one from canopy or top of canopy are identified. In another example, the quality indicator has a value of 1 if zero photons from terrain, but at least one photon from canopy or top of canopy are identified. In another example, if only photons from canopy (e.g., no terrain or top of canopy photons) are identified the value of the quality indicator equals

$$\frac{\# CanopyPhotons}{10}$$

(or 0.999 if the result is greater than 1). In another example, if only photons from terrain (e.g., no canopy or top of canopy photons) are identified the value of the quality indicator equals

$$\frac{\# TerrainPhotons}{100}$$

(or 0.999 is the result is greater than 0.1). In some implementations, process determines whether the calculation of the quality indicator meets a minimum threshold (i.e., an error margin) necessary to establish a quality indication.

At step 112, process 100 determines whether the quality indicator for each GCP is above a threshold value (e.g., any threshold value such as 0, 0.001, etc.). If process 100 determines the quality indicator is not above the threshold, at step 118 process 100 removes the GCP from the set of GCPs. ICESat-2 locations with a quality indicator greater than 0 are output to the final file (e.g., CSV file). The output can include information such as the longitude, latitude, DeltaH (maximum height—minimum height) at that location, a quality indicator, number of photons classified as terrain at that location, number of photons classified as canopy at that location, number of photons classified as top of canopy at that location, maximum height of all photons at that location, minimum height of all photons at that location, mean height of all photons at that location, maximum height of all terrain photons at that location, minimum height of all terrain photons at that location, and the mean height of all terrain photons at that location.

If the quality indicator is above the threshold value, at step 114, process 100 classifies (e.g., attribution or categorization) the GCPs using a DTM, a DSM, and land classification masks. Process 100 can use a canopy height model (CHM) to classify the GCPs. For example, a canopy height estimate from a global canopy model used in a DTM process. Process 100 can use a forest index to classify the GCPs. For example, an index from 1 to 100 with 1 indicating low probability of forest and 100 indicating a high probability of forest. The DTM process can use a threshold of 45 when creating a mask to distinguish between a forest and not a forest. Process 100 can use a slope mask to classify the CGPs. For example, 1 indicates a low slope, 2 indicates a mid-slope, 3 indicates a high slop, and 4 indicates a very high slope. Process 100 can use a landform classification to classify the CGPs. For example, 1 indicates flat, 2 indicates a summit, 3 indicates a ridge, 4 indicates a shoulder, 5 indicates a spur, 6 indicates a slope, 7 indicates a hollow, 8 indicates a foot slope, 9 indicates valley, and 10 indicates a depression.

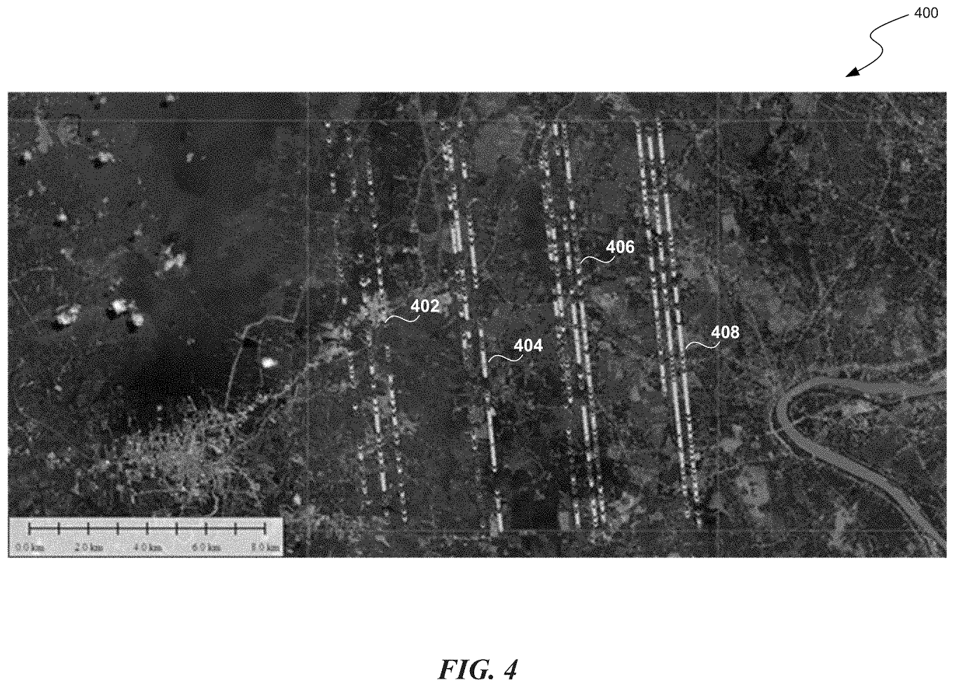

At step 116, process 100 filters the GCPs with a quality indicator value above the threshold value (from step 112). Process 100 can filter the GCPs based on GCPs on buildings that are not used in a DTM and can be used as DSM building height control points. In some implementations, process 100 can filter the GCPs based on the count of ICESat-2 points classified as terrain at the location. For example, a count greater than 1 filters points where ground was identified from the ICESat-2 data. Process 100 can filter the GCPs by a forest index. For example, a forest index value less than 30 filters points to areas expected to not be in a forest (i.e., unobstructed). Process 100 can filter the GCPs based on the DeltaH. For example, a small DeltaH value (e.g., less than 0.5 m) limits outlier ICESat-2 points. Process 100 can measure accuracy of a GCP by differencing the DTM elevation with the minimum height at the location. Example 400 of FIG. 4 illustrates filtered satellite data tracks 402, 404, 406, and 408.

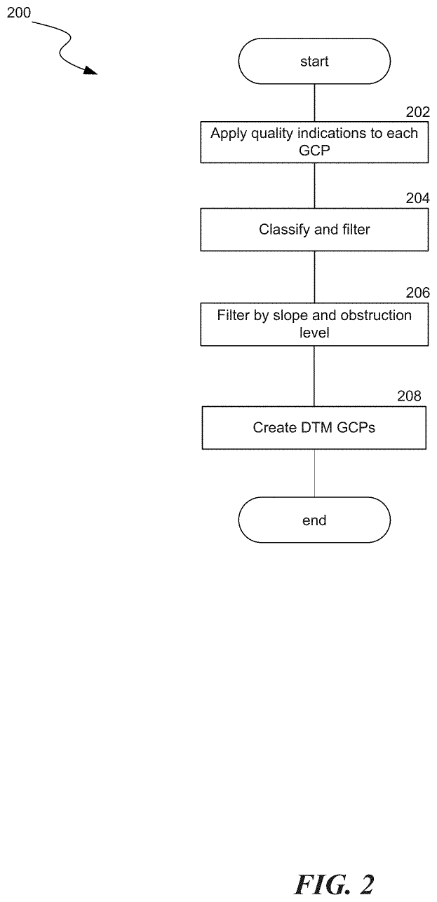

FIG. 2 is a flow diagram illustrating a process 200 used in some implementations for creating GCPs. In an embodiment, process 100 is triggered by satellite sending pulses of laser light to the earth's surface and collecting the returning photons, a user inputting a command, a GCP system deriving GCPs or, when receiving satellite data of LiDAR altitude measurement points.

At step 202, process 200 applies quality indications to each ICESat-2 derived DTM GCP. Process applies quality indications to the GCPs using the quantity of photons corresponding to each ICESat-2 class within a radius (e.g., any distance, such as 1-meter, 3-meter, 6-meter, etc.) of the GCP. The quality indicator can range from 0 to 1 and provide a metric of reliability for each GCP. In some implementations, if the quality indicator is 0, the GCP is removed from the set of GCPs.

At step 204, process 200 classifies and filters ICESat-2 derived DTM GCPs, based on DSM, DTM and classification mask data (e.g., building/bare earth/canopy). Process 200 can classify and filter GCPs using a building footprint data, water data, forest index data, and/or landform classification mask data. Process 200 can determine the accuracy of the ICESat-2 derived GCPs by differencing the DTM with the minimum photon height within the radius. Based on classifying and filtering, process 200 determines if the ICESat-2 measurement is a surface (DSM) or terrain (DTM) measurement.

At step 206, process 200 filters by slope and obstruction level to remove photons with high error probabilities. Process 200 can derive slope and obstruction level masks from airborne LiDAR DTM posted at the radius (e.g., 6 meters). Process 200 can filter out photons within high slope and high obstruction regions to improve the accuracy of ICESat-2 derived GCPs. Process 200 can filter the photon data representing the photons in the GCPs (e.g., GCPs with a quality indicator value above the threshold value from step 112 of FIG. 1) to identify and remove photons with high error probabilities.

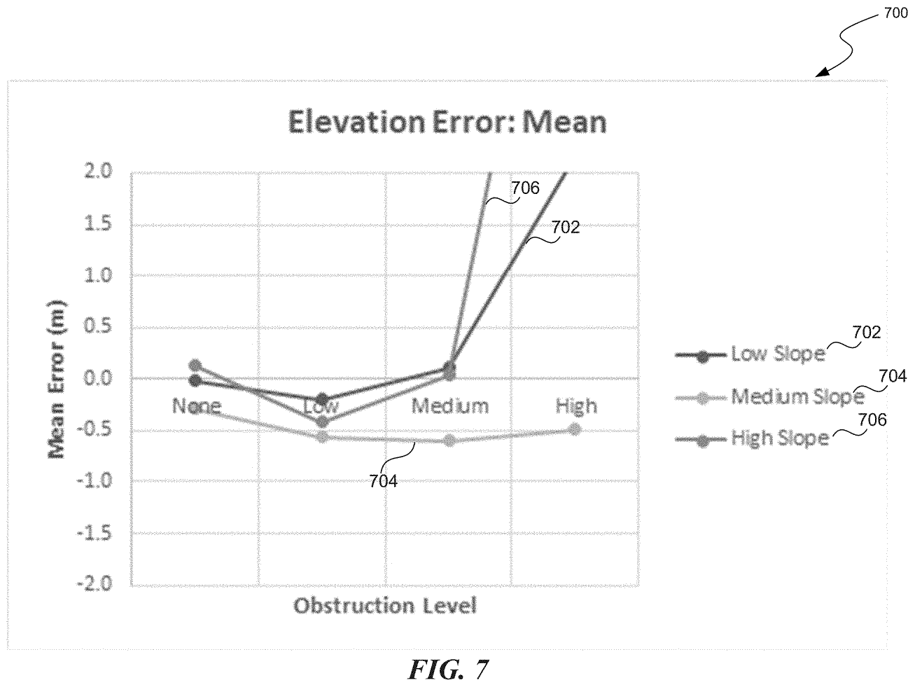

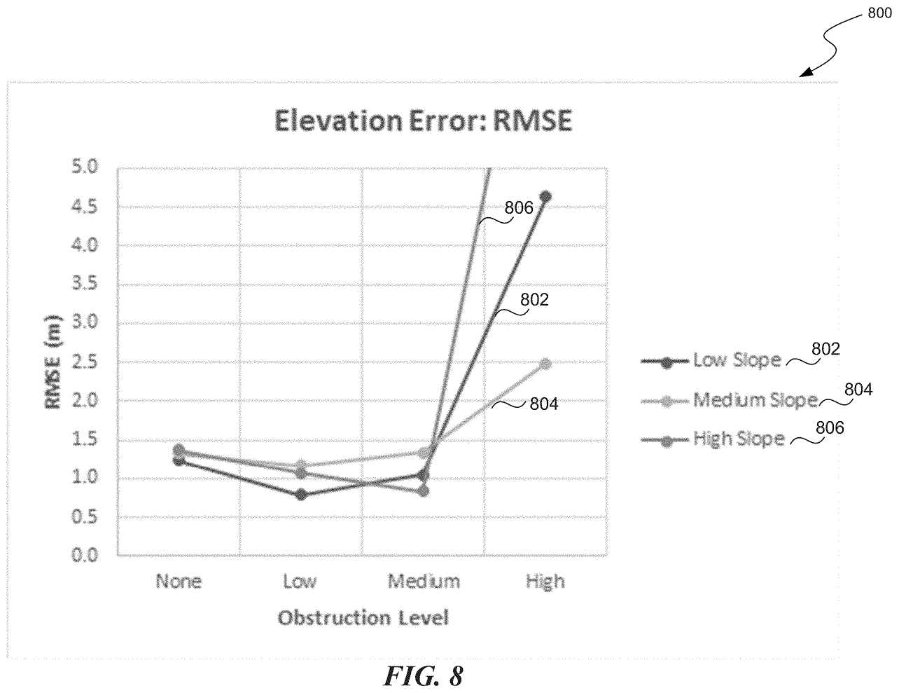

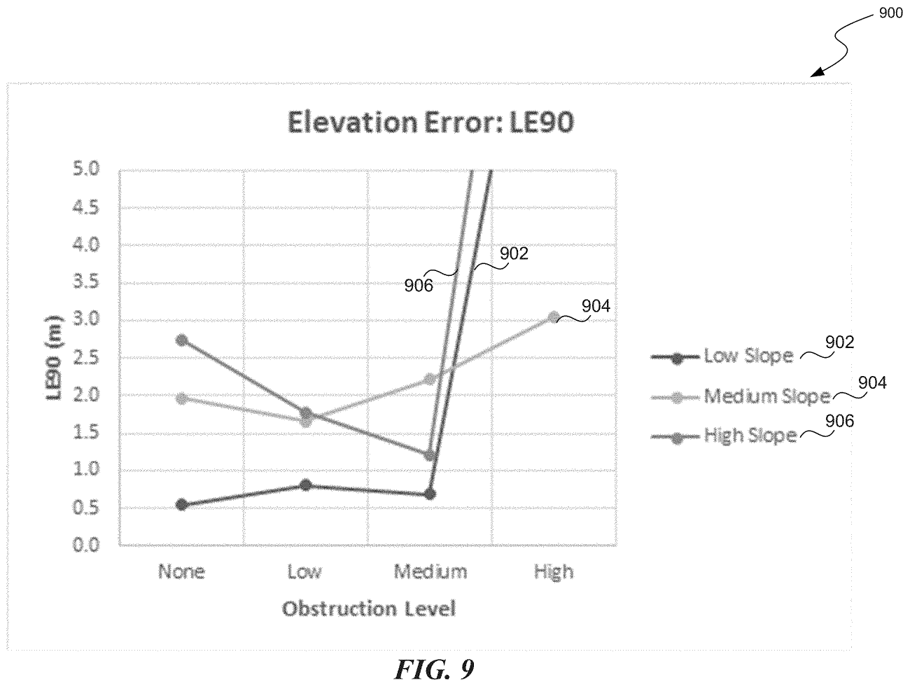

Example 700 of FIG. 7 illustrates a diagram of GCPs graphed by elevation error mean vs. obstruction level as shown by the low slope 702, the medium slope 704, and the high slope 706. Example 800 of FIG. 8 illustrates a diagram of GCPs graphed by root mean square error (RMSE) vs. obstruction level as shown by the low slope 802, the medium slope 804, and the high slope 806. Example 900 of FIG. 9 illustrates a diagram of GCPs graphed by 90th percentile linear error (LE90) vs. obstruction level as shown by the low slope 902, the medium slope 904, and the high slope 906. FIGS. 7-9 show that regardless of how error is measured (mean, RMSE or LE90), the error rate increases significantly with obstruction level. Mean error is lowest on medium slope. RMSE is higher on medium slopes up to medium obstruction levels than low or high, but is lowest in highly obstructed areas. If measured by LE90, the slope has a significantly lower error rate than medium or high slope in all but high obstruction levels, where medium slope areas have significantly lower error rates.

At step 208, process 200 creates ICESat-2 derived DTM GCPs in a canopy (e.g., a thick or dense canopy) using estimations of canopy height. Process 200 can use a global canopy model combined with the top of canopy measurement from ICESat-2 to estimate the terrain surface below the canopy in heavily forested regions. Conversely, where ICESat-2 measurement does penetrate a canopy (e.g. in a clearing), process 200 can use the ground measurements to fine-tune the canopy thickness model.

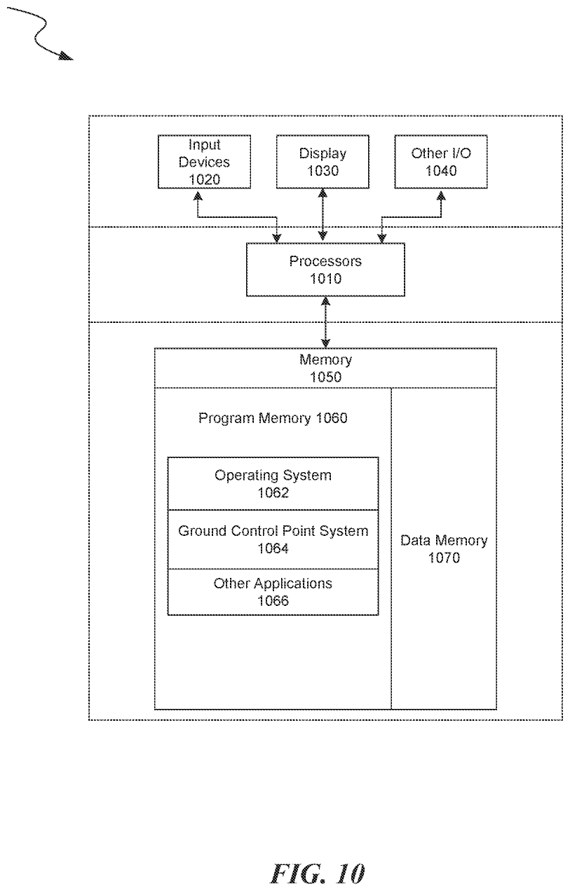

FIG. 10 is a block diagram illustrating an overview of devices on which some implementations of the disclosed technology can operate. The devices can comprise hardware components of a device 1000 that manage entitlements within a real-time telemetry system. Device 1000 can include one or more input devices 1020 that provide input to the processor(s) 1010 (e.g. CPU(s), GPU(s), HPU(s), etc.), notifying it of actions. The actions can be mediated by a hardware controller that interprets the signals received from the input device and communicates the information to the processors 1010 using a communication protocol. Input devices 1020 include, for example, a mouse, a keyboard, a touchscreen, an infrared sensor, a touchpad, a wearable input device, a camera- or image-based input device, a microphone, or other user input devices.

Processors 1010 can be a single processing unit or multiple processing units in a device or distributed across multiple devices. Processors 1010 can be coupled to other hardware devices, for example, with the use of a bus, such as a PCI bus or SCSI bus. The processors 1010 can communicate with a hardware controller for devices, such as for a display 1030. Display 1030 can be used to display text and graphics. In some implementations, display 1030 provides graphical and textual visual feedback to a user. In some implementations, display 1030 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1040 can also be coupled to the processor, such as a network card, video card, audio card, USB, firewire or other external device, camera, printer, speakers, CD-ROM drive, DVD drive, disk drive, or Blu-Ray device.

In some implementations, the device 1000 also includes a communication device capable of communicating wirelessly or wire-based with a network node. The communication device can communicate with another device or a server through a network using, for example, TCP/IP protocols. Device 1000 can utilize the communication device to distribute operations across multiple network devices.

The processors 1010 can have access to a memory 1050 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1050 can include program memory 1060 that stores programs and software, such as an operating system 1062, ground control point system 1064, and other application programs 1066. Memory 1050 can also include data memory 1070, LIDAR data, structure data, image data, beam data, GCP data, satellite data, quality indicator data, slope data, obstruction level data, mask data, terrain data, photon data, canopy data, height data, filter data, classification data, configuration data, settings, user options or preferences, etc., which can be provided to the program memory 1060 or any element of the device 1000.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

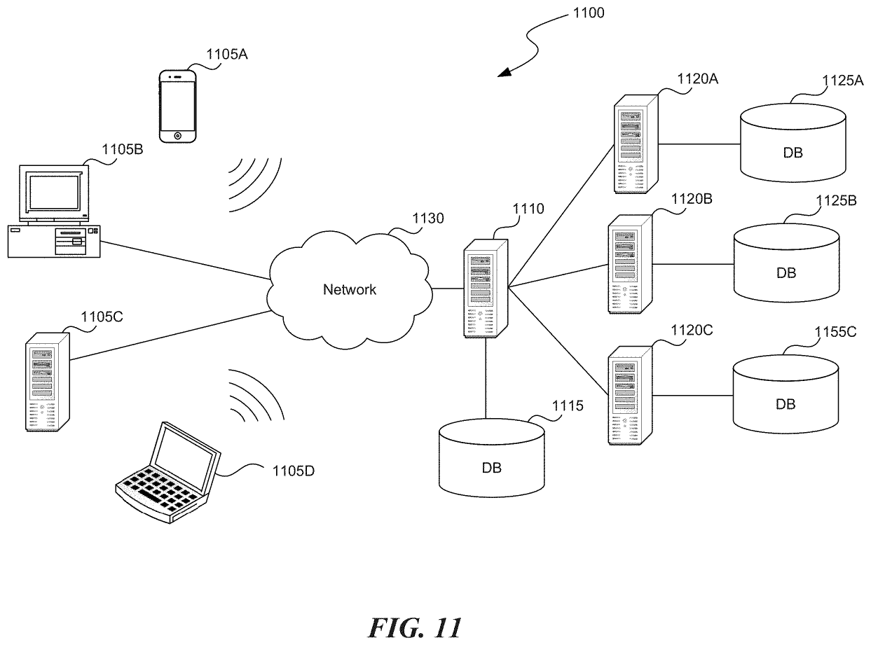

FIG. 11 is a block diagram illustrating an overview of an environment 1100 in which some implementations of the disclosed technology can operate. Environment 1100 can include one or more client computing devices 1105A-D, examples of which can include device 1000. Client computing devices 1105 can operate in a networked environment using logical connections through network 1130 to one or more remote computers, such as a server computing device 1110.

In some implementations, server 1110 can be an edge server which receives client requests and coordinates fulfillment of those requests through other servers, such as servers 1120A-C. Server computing devices 1110 and 1120 can comprise computing systems, such as device 1000. Though each server computing device 1110 and 1120 is displayed logically as a single server, server computing devices can each be a distributed computing environment encompassing multiple computing devices located at the same or at geographically disparate physical locations. In some implementations, each server 1120 corresponds to a group of servers.

Client computing devices 1105 and server computing devices 1110 and 1120 can each act as a server or client to other server/client devices. Server 1110 can connect to a database 1115. Servers 1120A-C can each connect to a corresponding database 1125A-C. As discussed above, each server 1120 can correspond to a group of servers, and each of these servers can share a database or can have their own database. Databases 1115 and 1125 can warehouse (e.g. store) information such as implement data, LIDAR data, structure data, image data, beam data, GCP data, satellite data, quality indicator data, slope data, obstruction level data, mask data, terrain data, photon data, canopy data, height data, filter data, and classification data. Though databases 1115 and 1125 are displayed logically as single units, databases 1115 and 1125 can each be a distributed computing environment encompassing multiple computing devices, can be located within their corresponding server, or can be located at the same or at geographically disparate physical locations.

Network 1130 can be a local area network (LAN) or a wide area network (WAN), but can also be other wired or wireless networks. Network 1130 may be the Internet or some other public or private network. Client computing devices 1105 can be connected to network 1130 through a network interface, such as by wired or wireless communication. While the connections between server 1110 and servers 1120 are shown as separate connections, these connections can be any kind of local, wide area, wired, or wireless network, including network 1130 or a separate public or private network.

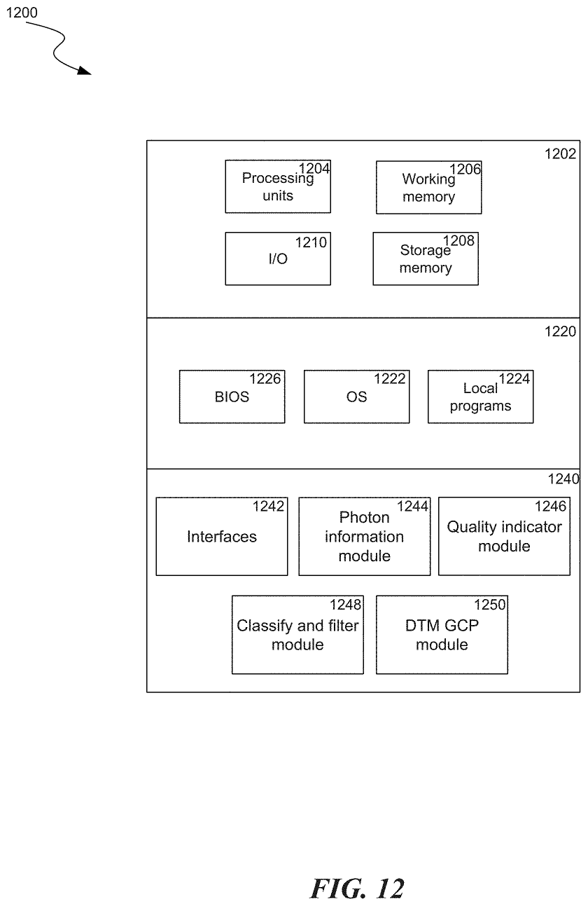

FIG. 12 is a block diagram illustrating components 1200 which, in some implementations, can be used in a system employing the disclosed technology. The components 1200 include hardware 1202, general software 1220, and specialized components 1240. As discussed above, a system implementing the disclosed technology can use various hardware including processing units 1204 (e.g. CPUs, GPUs, APUs, etc.), working memory 1206, storage memory 1208 (local storage or as an interface to remote storage, such as storage 1115 or 1125), and input and output devices 1210. In various implementations, storage memory 1208 can be one or more of: local devices, interfaces to remote storage devices, or combinations thereof. For example, storage memory 1208 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 1115 or storage provided through another server 1120). Components 1200 can be implemented in a client computing device such as client computing devices 1105 or on a server computing device, such as server computing device 1110 or 1120.

General software 1220 can include various applications including an operating system 1222, local programs 1224, and a basic input output system (BIOS) 1226. Specialized components 1240 can be subcomponents of a general software application 1220, such as local programs 1224. Specialized components 1240 can include photon information module 1244, quality indicator module 1246, classify and filter module 1248, DTM GCP module 1250, and components which can be used for providing user interfaces, transferring data, and controlling the specialized components, such as interfaces 1242. In some implementations, components 1200 can be in a computing system that is distributed across multiple computing devices or can be an interface to a server-based application executing one or more of specialized components 1240. Although depicted as separate components, specialized components 1240 may be logical or other nonphysical differentiations of functions and/or may be submodules or code-blocks of one or more applications.

In some embodiments, the photon information module 1244 is configured to extracts terrain and canopy information from the ICESat-2 data within a set radius for a specific GCP location. The ICESat-2 data can include photon information such as the longitude, latitude, DeltaH (maximum height—minimum height) at that location, number of photons classified as terrain at that location, number of photons classified as canopy at that location, number of photons classified as top of canopy at that location, maximum height of all photons at that location, minimum height of all photons at that location, mean height of all photons at that location, maximum height of all terrain photons at that location, minimum height of all terrain photons at that location, and the mean height of all terrain photons at that location.

In some embodiments, the quality indicator module 1246 is configured to calculate a quality indicator for a GCP based on photon information. In an example, the quality indicator has a value of 1 if at least one photon from terrain and one from canopy or top of canopy are identified. In another example, the quality indicator has a value of 1 if zero photons from terrain, but at least one photon from canopy or top of canopy are identified. In another example, if only photons from canopy (e.g., no terrain or top of canopy photons) are identified the value of the quality indicator equals

$$\frac{\# CanopyPhotons}{10}$$

(or 0.999 if the result is greater than 1). In another example, if only photons from terrain (e.g., no canopy or top of canopy photons) are identified the value of the quality indicator equals

$$\frac{\# TerrainPhotons}{100}$$

(or 0.999 if the result is greater than 0.1).

In some embodiments, the classify and filter module 1248 is configured to classify and filter derived GCPs, based on DSM, DTM and classification mask data (e.g., building/bare earth/canopy). The classify and filter module 1248 can classify and filter GCPs using a building footprint data, water data, forest index data, and/or landform classification mask data. The classify and filter module 1248 can determine the accuracy of the ICESat-2 derived GCPs by differencing the DTM with the minimum photon height within the radius.

In some embodiments, the DTM GCP module 1250 is configured to create DTM GCPs in a canopy using estimations of canopy height. The DTM GCP module 1250 can use a global canopy model combined with the top of canopy measurement from ICESat-2 to estimate the terrain surface below the canopy in heavily forested regions. Conversely, where ICESat-2 measurement does penetrate a canopy (e.g. in a clearing), the DTM GCP module 1250 can use the ground measurements to fine-tune the canopy thickness model

Those skilled in the art will appreciate that the components illustrated in FIGS. 10-12 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

Unless explicitly excluded, the use of the singular to describe a component, structure, or operation does not exclude the use of plural such components, structures, or operations. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

As used herein, the expression “at least one of A, B, and C” is intended to cover all permutations of A, B and C. For example, that expression covers the presentation of at least one A, the presentation of at least one B, the presentation of at least one C, the presentation of at least one A and at least one B, the presentation of at least one A and at least one C, the presentation of at least one B and at least one C, and the presentation of at least one A and at least one B and at least one C.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method comprising:
extracting, from satellite data, photon information based on measured photons for a location;
creating ground control points for the location based on the satellite data;
calculating a quality indicator for each ground control point using the photon information;
selecting a first set of ground control points based on the quality indicator for each of the first set of ground control points being above a threshold value;
classifying the first set of ground control points based on a digital surface model, a digital terrain model, and mask data; and
filtering photons in the first set of ground control points by slope and obstruction level to remove photons with an error probability above a threshold value.

2. The method of claim 1, wherein calculating the quality indicator further comprises:
identifying canopy photons and terrain photons in the photon information for the location.

3. The method of claim 1, wherein calculating the quality indicator further comprises:
identifying at least one photon from terrain and at least one photon from a canopy or a top of canopy at the location.

4. The method of claim 1, further comprising:
categorizing the photon information based on a canopy height model, a forest index, the slope associated with the photon information, and land-form classification.

5. The method of claim 1, further comprising:
creating digital terrain model ground control points based on canopy height estimations.

6. The method of claim 1, further comprising:
removing a second set of ground control points based on the quality indicator for each of the second set of ground control points being below the threshold value.

7. The method of claim 1, wherein the photon information includes photons classified as terrain at the location, photons classified as canopy at the location, or photons classified as top of canopy at the location.

8. A computing system comprising:
at least one processor; and
at least one memory storing instructions that, when executed by the processor, cause the computing system to perform a process comprising:
extracting, from satellite data, photon information based on measured photons for a location;
creating ground control points for the location based on the satellite data;
calculating a quality indicator for each ground control point using the photon information;
selecting a first set of ground control points based on the quality indicator for each of the first set of ground control points being above a threshold value;
classifying the first set of ground control points based on a digital surface model, a digital terrain model, and mask data; and
filtering photons in the first set of ground control points by slope and obstruction level to remove photons with an error probability above a threshold value.

9. The computing system of claim 8, wherein the process of calculating the quality indicator further comprises:
identifying canopy photons and terrain photons in the photon information for the location.

10. The computing system of claim 8, wherein the process of calculating the quality indicator further comprises:
identifying at least one photon from terrain and at least one photon from a canopy or a top of canopy at the location.

11. The computing system of claim 8, wherein the process further comprises:
categorizing the photon information based on a canopy height model, a forest index, the slope associated with the photon information, and land-form classification.

12. The computing system of claim 8, wherein the process further comprises:
creating digital terrain model ground control points based on canopy height estimations.

13. The computing system of claim 8, wherein the process further comprises:
removing a second set of ground control points based on the quality indicator for each of the second set of ground control points being below the threshold value.

14. The computing system of claim 8, wherein the photon information includes photons classified as terrain at the location, photons classified as canopy at the location, or photons classified as top of canopy at the location.

15. A non-transitory computer-readable storage medium including a set of instructions that, when executed by one or more processors, causes the one or more processors to perform operations comprising:
extracting, from satellite data, photon information based on measured photons for a location;
creating ground control points for the location based on the satellite data;
calculating a quality indicator for each ground control point using the photon information;
selecting a first set of ground control points based on the quality indicator for each of the first set of ground control points being above a threshold value;
classifying the first set of ground control points based on a digital surface model, a digital terrain model, and mask data; and
filtering photons in the first set of ground control points by slope and obstruction level to remove photons with an error probability above a threshold value.

16. The non-transitory computer-readable storage medium of claim 15, wherein the method of calculating the quality indicator further comprises:
identifying canopy photons and terrain photons in the photon information for the location.

17. The non-transitory computer-readable storage medium of claim 15, wherein the method of calculating the quality indicator further comprises:
identifying at least one photon from terrain and at least one photon from a canopy or a top of canopy at the location.

18. The non-transitory computer-readable storage medium of claim 15, wherein the method further comprises:
categorizing the photon information based on a canopy height model, a forest index, the slope associated with the photon information, and land-form classification.

19. The non-transitory computer-readable storage medium of claim 15, wherein the method further comprises:
creating digital terrain model ground control points based on canopy height estimations.

20. The non-transitory computer-readable storage medium of claim 15, wherein the method further comprises:
removing a second set of ground control points based on the quality indicator for each of the second set of ground control points being below the threshold value.
